(19) United States
(12) Patent Application Publication
(10) Pub. No.: US 2012/0208522 A1
(43) Pub. Date: Aug. 16, 2012

(54) Mobile Network Scanner Device

(75) Inventors: Nils Ulf Marklund, Skelleftea (SE); Michael Sven Anders Carlberg Lax, Skelleftea (SE); Johan Erik Magnus Nordfelth, Skelleftea (SE)

(73) Assignee: Ascom Network Testing Inc.

(21) Appl. No.: 13/025,832

(22) Filed: Feb. 11, 2011

(51) Int. Cl. H04W 24/00

(52) U.S. Cl. 455/422.1

(57) ABSTRACT

Various methods, systems, and computer program products are disclosed for scanning a mobile network using a device such as a tablet device. For example, a method may include scanning a mobile network at a plurality of locations of the mobile network. The method may further include determining one or more real-time measurements at a particular location among the plurality of locations of the mobile network based on the scan. The method may further include determining a location of one or more cells corresponding to the one or more real-time measurements. In other words, the location of one or more measured cells may be determined. The method may include displaying a user interface that displays a graphical representation of the one or more real-time measurements pointed from the particular location toward the location of the corresponding one or more cells.

### FIELD OF THE INVENTION

The disclosure relates to mobile network scanning devices and in particular to portable network scanner devices such as tablet computing devices configured to perform scans and analyze the mobile network.

### BACKGROUND OF THE INVENTION

Conventional mobile network scanners perform a wide range of activities related to scanning a mobile network. However, conventional scanners are typically expensive. Furthermore, power consumption of such conventional scanners is typically large, sometimes requiring up to 5 Amps of current at 12 Volts. Accordingly, these scanners often require bulky power supplies or a connected power source. Another drawback of conventional scanners is the form factor. Conventional scanners are usually large and either include hardware to display the scans (making the scanner even larger) or require connection to a separate display device. Thus, conventional scanners are not portable and not ideally suited for scanning while inside a building or other situations in which a user carries the scanner.

Furthermore, when scanning indoors using these and other conventional scanner devices, it is difficult to achieve an accurate pinpoint location for each measurement. For example, while scanning indoors, a user typically carries a conventional scanner device while travelling from one location to another. The user periodically enters a waypoint, which is what the user believes is a current location. During post-processing, a constant speed from one waypoint to another is assumed and intervening measurements between waypoints are averaged. In other words, an assumption is made that scans between waypoints are evenly space when in reality, they are likely not. As a result, inaccurate pinpointing of scans occurs. These and other drawbacks exist.

What is needed is a relatively inexpensive and portable device for scanning a mobile network while providing large displays for detailed and efficient assessment of the mobile network.

### SUMMARY OF THE INVENTION

Various methods, systems, and computer program products are disclosed for scanning a mobile network using a device such as a tablet device. According to various implementations of the invention, a method may include scanning a mobile network at a plurality of locations of the mobile network. Scanning at each location may occur at different times. In some implementations, the method may further include determining one or more real-time measurements at a particular location among the plurality of locations of the mobile network based on the scan. In some implementations, the method may include receiving a location indication. The location indication may indicate a location of the mobile network at which a corresponding one of the one or more real-time measurements are determined. The location indication may be received automatically through location-based services and/or manually such as from user input. In some implementations, the method may further include determining a location of one or more cells corresponding to the one or more real-time measurements. In other words, the location of one or more measured cells may be determined. In some implementations, the method may include displaying a user interface that displays a graphical representation of the one or more real-time measurements pointed from the particular location toward the location of the corresponding one or more cells.

According to various implementations of the invention, a method may include scanning a mobile network at a plurality of locations of the mobile network. Scanning at each location may occur at different times. In some implementations, the method may include determining one or more measurements at each of a corresponding one of the plurality of locations of the mobile network based on the scan. In some implementations, the method may include, for each of the plurality of locations, receiving a location indication. The location indication may indicate a location of the mobile network at which a corresponding one of the one or more measurements are determined. In some implementations, the method may include generating a user interface that displays a heat map based on the one or more measurements and corresponding location indications, wherein the heat map differentiates a first measurement at a first location from a second measurement at a second location.

### BRIEF DESCRIPTION OF THE DRAWINGS

The accompanying drawings, which are incorporated into and constitute a part of this specification, illustrate one or more examples of implementations of the invention and, together with the description, serve to explain various principles and aspects of the invention.

FIG. 1 is a block diagram illustrating a system of scanning a mobile network, according to various implementations of the invention.

FIG. 2 is a screen shot illustrating an example of a user interface in multi-cell mode, according to various implementations of the invention.

FIG. 3 is a screen shot illustrating an example of a user interface in multi-cell mode with directional indication of cells, according to various implementations of the invention.

FIG. 4 is a screen shot illustrating an example of a user interface in menu mode, according to various implementations of the invention.

FIG. 5 is a screen shot illustrating an example of a user interface in heat map mode, according to various implementations of the invention.

FIG. 6 is a screen shot illustrating an example of a user interface in bar chart mode, according to various implementations of the invention.

FIGS. 7A and 7B are diagrams illustrating components of a user interface, according to various implementations of the invention.

FIG. 8 is a flow diagram illustrating an example of a process of scanning a mobile network, according to various implementations of the invention.

### DETAILED DESCRIPTION OF THE INVENTION

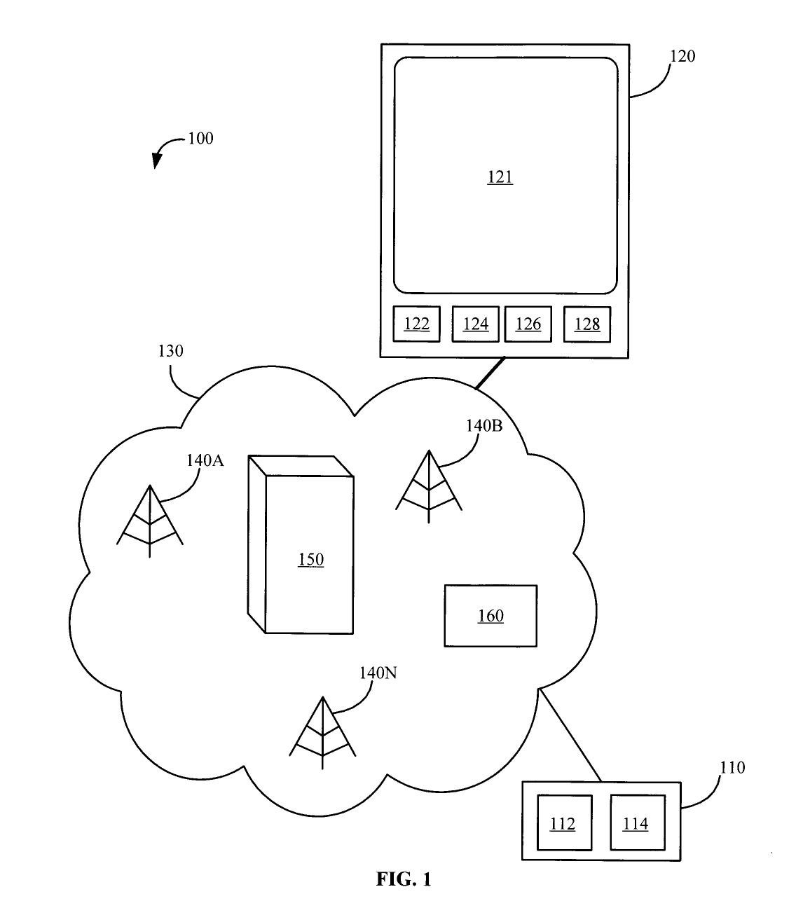

FIG. 1 is a block diagram illustrating a system 100 of scanning a mobile network 130, according to various implementations of the invention. In some implementations, mobile network 130 comprises of one or more cells that each serve a mobile device (not illustrated in FIG. 1). In some implementations, mobile network 130 includes various types of radio access technology such as, for example, GSM, CDMA, WCDMA, and/or other types of technologies. In some implementations, system 100 may be used to visualize measurements of one or more cells based on scans made by a mobile network scanner device 120 (hereinafter referred to interchangeably with “device 120” for convenience). In some implementations, device 120 may include a tablet computer that has been configured to perform the scanning and/or analysis functions described herein. In these implementations, a low cost yet effective solution may be achieved that combines the form factor of a tablet, integrated scanning functions, and rich user interfaces. However, as would be appreciated, device 120 may include a laptop computer, a cellular phone, or other device configured to scan mobile network 130 and perform functions described herein.

In some implementations, device 120 may be used to scan mobile network 130 indoors such as inside a building 150 or outdoors such as from a vehicle 160 travelling outdoors. In some implementations, device 120 displays real-time measurements. In other words, as device 120 traverses different locations, device 120 may display measurements in real-time so that the display is different from one location to the next depending on the measurements at those locations. In some implementations, device 120 displays measurements from only locations in which a user inputs a location or otherwise indicates storage of the measurements is desired. In these implementations, a historical view or heat map may be displayed that simultaneously displays multiple scan locations in order to determine potential problem areas of mobile network 130.

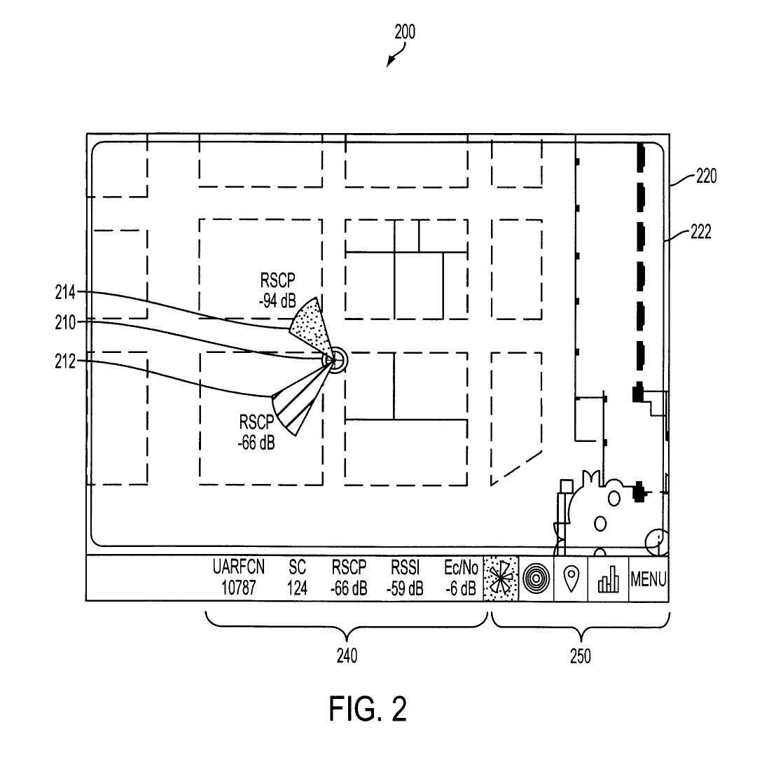

In some implementations, device 120 generates multi-dimensional user interfaces (illustrated by example and not by limitation by interfaces 200, 300, 400, 500, 600, and 700 of FIGS. 2, 3, 4, 5, 6, and 7B). The user interfaces facilitate an efficient and detailed understanding of mobile network 130. For example, the particular displays of the user interface may be used to identify problematic locations, display underlying measurements that indicate the problem, indicate locations of cells associated with the problem, and/or provide other diagnostic information.

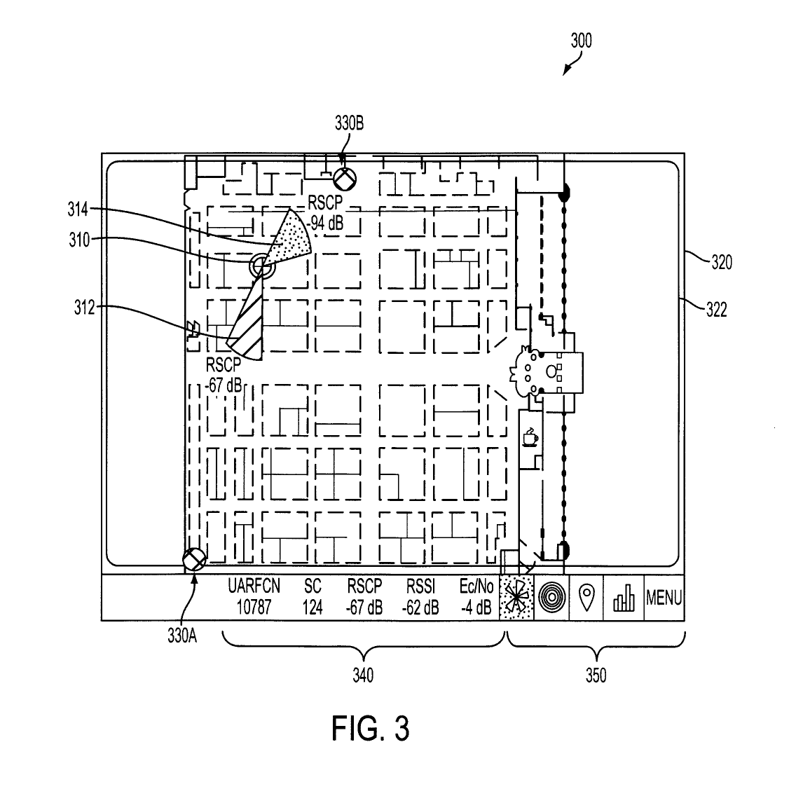

In some implementations, for example, device 120 may generate a user interface that displays a floor plan of the inside of a building 150 (such as an office building, hotel, parking garage, or other structure) in which scans take place. Unless otherwise noted, reference will be made to FIG. 3 with respect to the user interface generated by device 120. In some implementations, graphical representations of the measurements may be displayed with respect to the floor plan. In some implementations, device 120 may generate a user interface that indicates a location of various cells of mobile network 130. In some implementations, device 120 may depict various measurements using graphical objects that are shaped and/or oriented in a manner that point to a responsible cell, so that the direction of the cell with respect to the measurement location is illustrated. In implementations that include multiple cells in mobile network 130, pointing to the responsible cell facilitates identification and location of problematic cell(s). In some implementations, device 120 may generate a user interface that displays hotspots so that problem areas may be quickly identified.

In some implementations of the invention, device 120 may scan mobile network 130 at a plurality of locations of mobile network 130. In other words, device 120 may be moved throughout various locations of mobile network 130 so that the various locations may be scanned. For example, device 120 may be carried by a user walking within building 150 while scanning mobile network 130. In another example, device 120 may be within a moving vehicle 160 while scanning mobile network 130. In some implementations, real-time measurements may be displayed. In other words, in some implementations, scans may be displayed in real-time. In some implementations, scans of each location may be stored, such as in memory 128, for later retrieval. In other implementations, only some scans are stored.

In some implementations of the invention, device 120 may receive a location indication for at least one of the plurality of locations, wherein the location indication indicates a location of device 120 during the scan. The location indication may be manual such as input from a user or automatic such as from a location-based service. In some implementations, a user may input the location indication at different times. In some implementations, the user may input the location indication by touching or otherwise selecting a location on a map displayed by device 120. In some implementations, the user may input the location indication by touching or otherwise selecting a location on a floor plan displayed by device 120. In some implementations, the location indication may include Global Positioning System (GPS) information, or other location-based information such as signal strength from base stations 140 whose locations are known.

In some implementations, device 120 may determine one or more real-time measurements at a particular location among the plurality of locations of mobile network 130 based on the scan. A real-time measurement may indicate quality of mobile network 130 at each location at a particular time. In practice, a real-time measurement may fluctuate over time based on the radio environment. In some implementations, the measurement is a raw value resulting from the scan. In other implementations, the raw value is processed by performing calculations or other processing operations on the raw value to obtain the measurement. In some implementations, the measurements are different depending on a type of Radio Access Technology (RAT) being used. For instance, Tables 1 and 2 below illustrates non-limiting examples of two types of RAT and corresponding example measurements resulting from the scan. As would be appreciated, other types of RAT and other measurements may be used.

TABLE 1
Global System for Mobile Communication (GSM) measurements.
Information provided for each scanned GSM frequency/cell.

| ARFCN | 26 (E-GSM) |
|---|---|
| RxLev | −80 |
| FrameOffset | 0 |
| QuarterBitOffset | 0 |
| BSIC | 2-1 |
| T1 | 1401 |
| T2 | 18 |
| T3′ | 1 |

TABLE 2
Wideband Code Division Multiple Access (W-CDMA) measurements.
Information provided for each scanned WCDMA scrambling code/cell.

| | |
|---|---|
| UARFCN | 10836 |
| Primary Scrambling Code | 32 |
| RSSI | −86.31 |
| RSCP | −88.74 |
| Ec/N0 | −2.43 |

Path Information:

| | |
|---|---|
| [0]: | Slot offset: 10 |
| | Q chip offset: 1252 |
| | RSCP: −90.71 |
| [1]: | Slot offset: 10 |
| | Q chip offset: 1246 |
| | RSCP: −94.67 |
| [2]: | Slot offset: 10 |
| | Q chip offset: 1258 |
| | RSCP: −100.31 |
| [3]: | Slot offset: 10 |
| | Q chip offset: 1262 |
| | RSCP: −105.22 |
| [4]: | Slot offset: 10 |
| | Q chip offset: 1240 |
| | RSCP: −107.63 |
| [5]: | Slot offset: 10 |
| | Q chip offset: 1266 |
| | RSCP: −112.93 |

In some implementations, device 120 may determine a location of one or more cells corresponding to the real-time measurements. In other words, device 120 may determine a location of a measured cell.

In some implementations, device 120 may generate a user interface that displays a graphical representation 312, 314 of the one or more real-time measurements. In some implementations, graphical representation 312, 314 may be pointed from the particular location to the location of the corresponding one or more cells. In this manner, measurements of a cell may be related to a location of the cell with respect to a location of the scan.

In some implementations, device 120 displays the user interface via a display device 121. In some implementations, the user interface may be communicated to a remote device such as server 110.

In some implementations of the invention, device 120 may receive a floor plan of building 150. According to various implementations, the floor plan (which may include one or more floor plans) may be received via mobile network 130, wirelessly using one or more wireless protocols, via Universal Serial Bus input, or other methods of transferring data. In these implementations, device 120 may display the floor plan, and receive the location indication based on the displayed floor plan. In some implementations, the floor plan may be received via a bitmap image file, a vector file, or other file format suitable to be displayed by device 120.

In some implementations of the invention, device 120 may display the floor plan as a background image 320 and generate the user interface by overlaying at least a portion of the user interface onto background image 320. In these implementations, locations of the user interface may be mapped to the floor plan so that they correspond with one another according to various known coordinate translation and/or other graphical techniques.

In some implementations of the invention, device 120 may receive at least one cell location that indicates a location of at least one cell of mobile network 130. In these implementations, device 120 may display, via the user interface, at least one cell location indication 330 (illustrated in FIG. 3 as cell location indications 330A and 330B) that indicates the location of the at least one cell. In this manner, the location of a cell that may be responsible for a problem in mobile network 130 can be readily discerned using the user interface. In some implementations, the at least one cell location is received via a file or other format that communicates cell locations within mobile network 130. The cell location information may be received using techniques described above with respect to received floor plans.

In implementations where cell locations are not received, a cell location indication 330 may be generated and located at random or evenly spaced locations throughout the user interface for each detected cell. In these implementations, the cell location indication represents the unknown location. In this manner, even when cell locations are not received or otherwise unknown, cells may be separately discerned from one another.

In some implementations of the invention, device 120 may display a mobile network scanner device location indication 310 (used interchangeably with “device location indication 310”) based on the received location indication. In some implementations, device location indication 310 includes a graphical object that indicates where device 120 was located when the corresponding measurements for that location was made. In some implementations, device location indication 310 is shaped as a cross-hair. As would be appreciated, however, other graphical objects may be used.

In some implementations of the invention, device 120 may display the one or more measurements as a graphical object (illustrated in FIG. 3 as graphical representations 312, 314) pointed substantially from the device location indication 310 toward the at least one cell location indication 330. As illustrated in FIG. 3, for example, graphical representation 312 points toward cell location indication 330A and graphical representation 314 points toward cell location indication 330B. In this manner, the user interface indicates a location of a measured cell relative to the location at which the measurement took place as well as the actual measurement data.

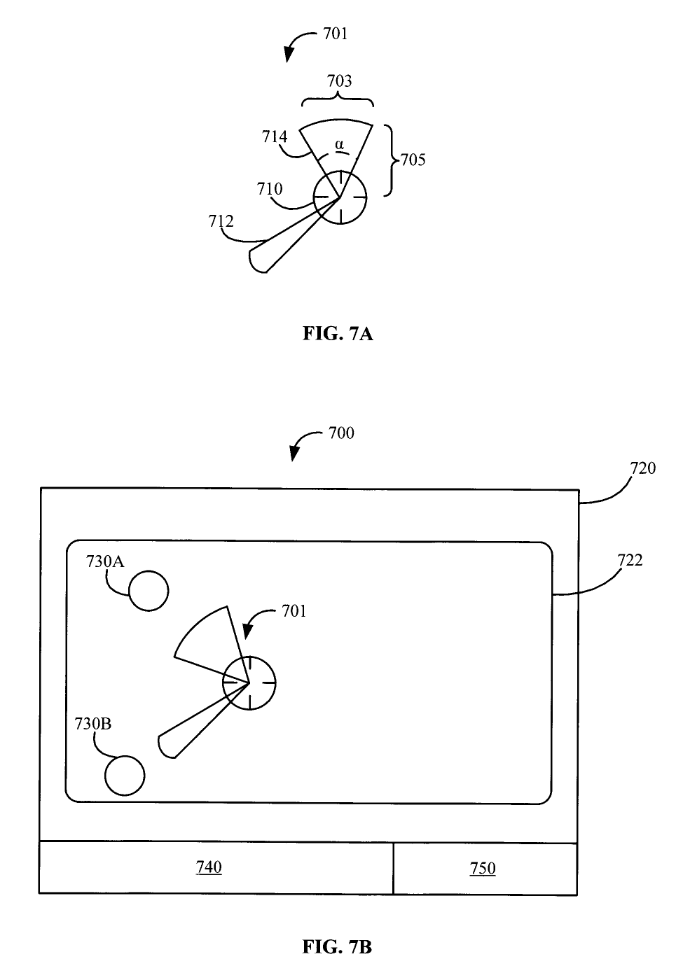

In some implementations, the size and/or shape of the graphical object may be determined based on values of the one or more measurements. For example, referring to FIG. 7A, a width of an arc 703 of the conical shape may be determined by a first measurement (such as Ec/No) while a length of arms 705 of the conical shape may be determined by a second measurement (such as RSCP). The width may be based on an angle α of the conical shape. In some implementations, although illustrated as conically shaped, graphical representations 312 and 314 may include other shapes that can be pointed toward a cell location indication 330.

Referring to FIG. 3, cell location indication 330A represents the location of a first cell of mobile network 130 with a measured RSCP value of −94 dB while cell location indication 330B represents the location of a second cell of mobile network 130 with a measured RSCP value of −67 dB. Cell location indication 330 may be illustrated as a circle (as illustrated in FIG. 3) or other graphical representation. In some implementations, either or both cell location indications 330 may not reflect an actual location of the cell but may be instead illustrated at the edge of the user interface. In this manner, cell location indications 330 may reflect the direction of a corresponding cell relative to the view provided by the user interface. In some implementations, an approximate distance to the cell and/or other information describing the cell may be provided by the user interface.

In some implementations of the invention, device 120 may receive a selection of a graphical representation 312, 314 that represents one or more measurements of a corresponding cell at a particular location indicated by device location indication 310. In other words, a user may select one of the conically shaped graphical representation 312, 314 in order to drill-down and view additional information associated with the corresponding cell. In some implementations, the selected graphical representation 312, 314 may be displayed differently to indicate the selection. In some implementations, the selected graphical representation 312, 314 is highlighted, colored darker, outlined, and/or made different using other techniques.

In some implementations, based on the received selection, device 120 may display the additional information in information panel 340. In some implementations, information panel 340 may include the one or more measurements corresponding to the selected cell.

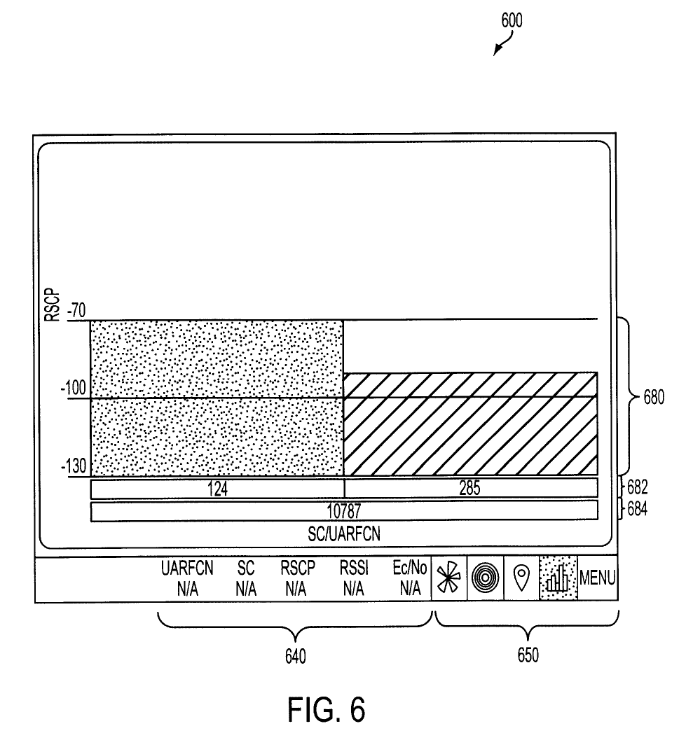

In some implementations of the invention, device 120 may generate a heat map display (illustrated in FIG. 6), wherein the heat map display is configured to display a first measurement of a corresponding first location differently than a second measurement of a corresponding second location based on their respective measurements and their respective locations. In these implementations, the heat map display facilitates efficient identification of problem spots within the mobile network.

According to various implementations of the invention, system 100 may include, for example, device 120, base stations 140 (illustrated in FIG. 1 as base station 140A, 140B, . . . , 140N), mobile network 130, and a server 110. In some implementations, mobile network 130 may be coupled to other communication networks (not illustrated in FIG. 1) such as a Local Area Network, a Wide Area Network, a Public Switched Telephone Network, and/or other network or combination of networks. In some implementations, device 120, base stations 140, and server 110 may be communicably coupled to one another via mobile network 130 and/or other communication networks. As would be appreciated, each base station 140 may be responsible for one or more network cells (not illustrated in FIG. 1) of mobile network 130.

In some implementations, device 120 may include, among other things, a display device 121, a transceiver 122, an integrated broadband chip 124, a processor 126 (which may include one or more processors), and a memory 128. In some implementations, display device 121 may include, for example, a touch screen or other display that allows users to interact with the user interface and/or other functions provided by device 120. In some implementations, transceiver 122 facilitates communications between device 120 and other devices via mobile network 130. In some implementations, integrated broadband chip 124 may be configured to perform scans of mobile network 130.

In some implementations, memory 128 includes one or more tangible (i.e., non-transitory) computer readable media. In some implementations, memory 128 may include one or more instructions that when executed, configure processor 126 and/or integrated broadband chip 124 to perform the functions of device 120 described herein. In some implementations, device 120 includes an off-the-shelf tablet or other computing device with integrated broadband chip 124 that is configured with instructions to perform functions described herein.

In some implementations, at least a portion of the functions of device 120 may be performed at a remote device such as server 110. In other words, server 110 may be configured to perform some or all of the functions performed by device 120. In these implementations, for example, server 110 may be communicably coupled to device 120 such that some or all information (such as measurements, allocations, etc) required to complete the functions are communicated between the two. In these implementations, some or all of the described functions of device 120 is performed by either or both server 110 and device 120.

According to various implementations of the invention, server 110 may include processor 112, memory 114, and/or other components that facilitate the functions of server 110 described herein. In some implementations, processor 112 includes one or more processors configured to perform various functions of server 110. In some implementations, memory 114 includes one or more tangible (i.e., non-transitory) computer readable media. Memory 114 may include one or more instructions that when executed by processor 112 configure processor 112 to perform the functions of server 110. In some implementations, memory 114 may include one or more instructions stored on tangible computer readable media that when executed at a remote device, such as device 120, cause the remote device to scan mobile network 130 and/or generate user interfaces described herein.

FIG. 2 is a screen shot illustrating an example of a user interface 200 in multi-cell mode, according to various implementations of the invention. FIG. 2 and other drawing figures that illustrate examples of displays or screenshots are for illustrative purposes only. User interfaces may include, reconfigure, or exclude some graphical elements illustrated while adding other graphical elements not otherwise illustrated in the figures as would be appreciated.

According to various implementations of the invention, user interface 200 may include, among other things, a background image 220, an overlay 222, an information panel 240, and a navigation panel 250. User interface 200 may be scrolled in various directions, zoomed in and out, or otherwise manipulated as would be appreciated.

In some implementations of the invention, background image 220 may include one or more images such as, for example, a floor plan of a building for which its interior is being scanned, a geographic or other map, and/or other images. As such, although illustrated in FIG. 2 and other drawings figures as a floor plan, background image 220 may include other images or no image. In some implementations of the invention, background image 220 may be stored in a memory of a device (such as device 120 illustrated in FIG. 1) that displays user interface 200. For example, background image 220 may be transferred to the device using any wired or wireless technique.

In some implementations of the invention, overlay 222 may be overlaid onto background image 220. “Overlaying” overlay 222 onto background image 220 may include making background image 220 and/or overlay 222 semi-transparent so that background image 220 and overlay 222 are simultaneously made visible. Either background image 220 or overlay 222 may be in the background while the other is in the foreground. For example, “overlaying” onto background image 220 may include background image 220 in the background while overlay 222 is in the foreground and vice versa, so long as both are simultaneously visible. Furthermore, “overlaying” may also include directly incorporating various graphical features of overlay 222 into background image 220 and vice versa using various known graphical manipulation techniques.

In some implementations of the invention, user interface 200 may include various graphical objects (illustrated in FIG. 2 by reference indicators 210, 212, 214). In some implementations, the graphical objects may be depicted on overlay 222. In some implementations, overlaying may also include mapping coordinates or locations of background image 220 to overlay 222 and vice versa. In this manner, when simultaneously displayed, selecting or viewing a particular location of the overlay 222 corresponds to a particular location of background image 220. Thus, locations of overlay 222 may be coincident with locations of a floor plan or a map. As such, location of graphical objects on overlay 222 may represent their location on the floor plan or map.

In some implementations of the invention, the graphical objects may represent one or more measurements based on scanning at a particular location. For example, the particular location may be indicated by a scanner device location indication 210. As illustrated, scanner device location indication 210 is depicted as a cross-hair graphical object but can be any other graphical representation that indicates the location.

In some implementations of the invention, the one or more measurements may correspond to measurements of one or more cells. For example, as illustrated, graphical representations 212, 214 respectively represent measurements of first and second cells (not illustrated in FIG. 2) at scanner device location indication 210. In this manner, various measurements and quality of cells of a mobile network may be easily and separately assessed for a given location.

Although illustrated as conically shaped, graphical representations 212, 214 may be shaped using lines, arrows, squares, and/or other graphical representation. In some implementations of the invention, visual attributes such as the size, color, and/or shape of graphical representations 212, 214 may be based on the measurements in which they represent. For example, measurements indicating “good” quality may result in longer, wider, or particularly colored graphical representations, as discussed further with respect to FIG. 7A.

In some implementations of the invention, graphical representations 212, 214 may be selectable such that upon selection, additional information is displayed for a corresponding cell with which graphical representations 212, 214 is associated. In some implementations of the invention, the additional information is displayed by information panel 240. In some implementations of the invention, the additional information includes additional measurements of a corresponding cell. For example, when a selection of graphical representation 212 is received, additional information for the first cell is displayed by information panel 240. Likewise, when a selection of graphical representation 214 is received, additional information for the second cell is displayed by information panel 240.

In some implementations of the invention, upon selection, the selected graphical representation 212, 214 may be highlighted or otherwise altered to indicate the selection so that it is clear to which cell the additional information pertains. In some implementations of the invention, navigation panel 250 may be used to navigate between different views illustrated in FIGS. 2 through 6.

Unless otherwise noted, various functionality of user interface 200 such as scrolling, overlaying, displaying objects, displaying information via information panel 240, navigating via navigation panel 250, and others, apply to similar user interfaces such as user interfaces 300, 400, 500, 600, and 700 illustrated in other drawing figures. Similarly, features of graphical representations 210, 212, 214 apply to like-numbered graphical representations (such as 310, 312, 314, 410, 412, 414, and so forth) in other figures.

FIG. 3 is a screen shot illustrating an example of a user interface 300 in multi-cell mode with directional indication of cells, according to various implementations of the invention. According to various implementations of the invention, user interface 300 may include, among other things, a background image 320, an overlay 322, an information panel 340, and a navigation panel 350. User interface 300 may be scrolled in various directions, zoomed in and out, or otherwise manipulated as would be appreciated.

According to various implementations of the invention, user interface 300 may illustrate a relative location of one or more cells being measured. As illustrated, graphical representation 312 represents one or more measurements of a first cell whose relative location is indicated by cell location indication 330A and graphical representation 314 represents one or more measurements of a second cell whose relative location is indicated by cell location indication 330B. However, one or any other number of cells may be represented.

In some implementations of the invention, as illustrated in FIG. 3, graphical representations 312, 314 may each be pointed toward respective cell location indications 330A, 330B. In this manner, measurements represented by graphical representations 312, 314 may be graphically associated with a relative location of the source of the measurements (namely a measured cell).

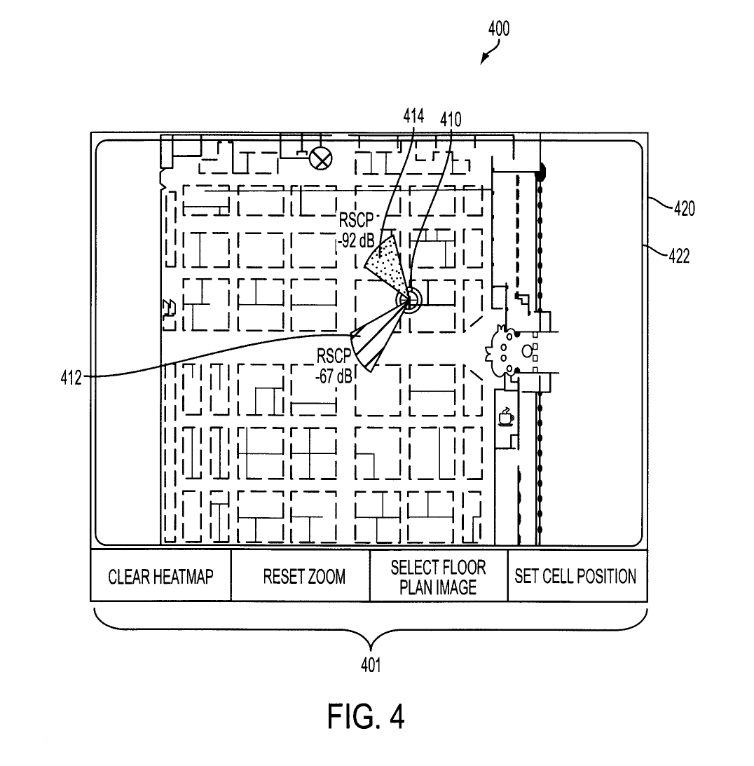

In some implementations of the invention, cell location indications 330 may be derived from cell data stored on a memory of a device, such as device 120 illustrated in FIG. 1. In some implementations of the invention, the cell data may be in the form of a file, database, or other storage that indicates a location, identity, and/or other information associated with a cell. In some implementations of the invention, the cell data is transferred to the memory of the device using wireless or wired techniques. In some implementations of the invention, a user may enter cell data as described below with respect to FIG. 4.

In some implementations of the invention, a cell location indication 330 may not indicate the actual location of the cell but rather the relative location with respect to scanner device location indication 310 (where the measurements were taken). In some implementations of the invention, cell location indication 330 may indicate the actual location such as when a cell, repeater, or other access point is actually located at or near a location indicated by cell location indication 330.

In some implementations of the invention, detected cells are compared against the cell data to determine which detected cells have known locations based on the cell data. When a match is found, a cell location indication 330 may be displayed based on the known location.

In some implementations of the invention, when the location of a cell is unknown (i.e., cell data is unavailable), a cell location indication 330 may be used at a random or evenly-spaced location around user interface 300 to be able to discern separate cells. In these implementations, such a cell location indication 330 may be highlighted or otherwise displayed differently to indicate that the location of the cell is unknown. Thus, some or all cell locations depicted by user interface 300 may be known or unknown and illustrated accordingly.

FIG. 4 is a screen shot illustrating an example of a user interface 400 in menu mode, according to various implementations of the invention. According to various implementations of the invention, user interface 400 may include, among other things, a background image 420, an overlay 422, and a menu panel 401. User interface 400 may be scrolled in various directions, zoomed in and out, or otherwise manipulated as would be appreciated. In some implementations, the menu mode is presented based on a selection of the menu mode within a navigation panel 250 as illustrated in FIG. 2, for example.

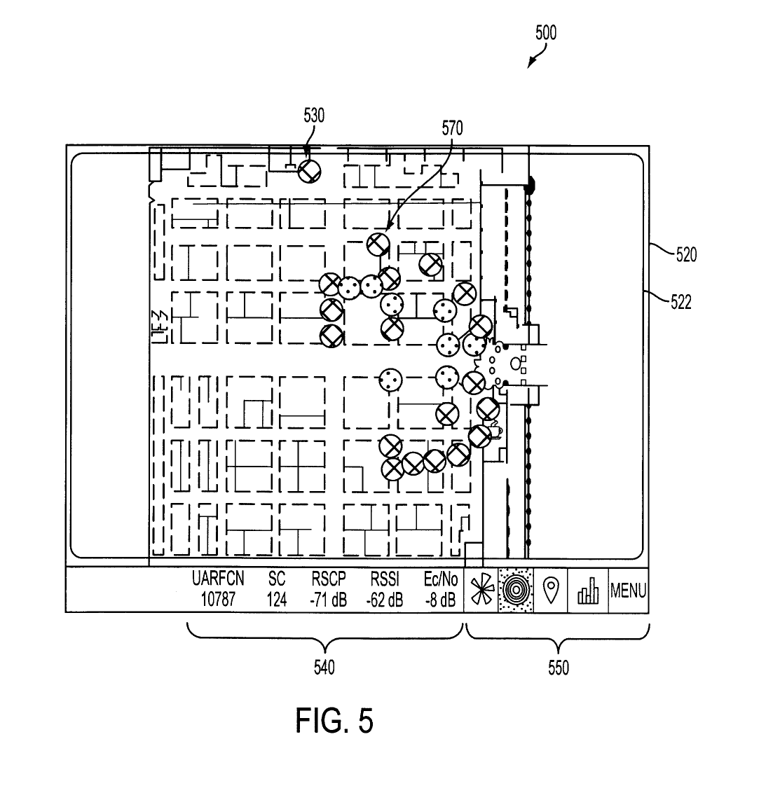

In some implementations of the invention, menu panel 401 may include various selectable functions that control user interface 400, such as, among others, “clear heatmap,” “reset zoom,” “select floor plan/image,” and “set cell position.” In some implementations, clear heatmap resets the heatmap view (illustrated in FIG. 5). In some implementations, reset zoom may reset the zoom level to a default or starting zoom level. In some implementations, select floor plan/image allows a user to select from among floor plans, maps, or other images to load as background image 420. In some implementations of the invention, set cell position allows a user to enter cell data such as the cell position. In some implementations of the invention, the user may set the cell position by selecting a location on user interface 400 to indicate the cell location.

FIG. 5 is a screen shot illustrating an example of a user interface 500 in heat map mode, according to various implementations of the invention. According to various implementations of the invention, user interface 500 may include, among other things, a background image 520, an overlay 522, an information panel 540, and a navigation panel 550. User interface 500 may be scrolled in various directions, zoomed in and out, or otherwise manipulated as would be appreciated. In some implementations, the menu mode is presented based on a selection of the menu mode within a navigation panel 550.

In some implementations of the invention, the heat map mode displays a heat map display that illustrates hotspots 570. In some implementations of the invention, each hotspot 570 indicates a location at which one or more measurements were taken as well as an indication of the quality of a measurement at each location.

In some implementations, the indication may include different shapes, sizes, or colors of a hotspot 570 to indicate the quality. For example, a “good” measurement may be shown in green, a below average measurement may be shown in yellow, and a “poor” measurement may be shown in red. As would be appreciated, however, different colors and different shades of colors may be used. In this manner, an overview across various locations of the mobile network being scanned may be presented. For example, based on hotspots 570, particular locations that have poor measurements may be ascertained. Furthermore, by using multidimensional displays, further detail on each hotspot may be viewed, such as the view illustrated in FIG. 2.

In some implementations of the invention, hotspots 570 may represent individual types of measurements. For example, hotspots 570 may illustrate RSCP measurements, RSSI measurements, or other types of measurements. In these implementations, different types of measurements may be selected for viewing hotspots 570. In other words, different hotspots 570 may be viewed for different types of measurements.

In some implementations of the invention, hotspots 570 may represent a combination of two or more types of measurements. For example, hotspots 570 may represent a composite score based on a combination of RSCP measurements, RSSI measurements, and/or other types of measurements. In these implementations, different composite scores may result in different shapes, sizes, colors, etc., for different hotspots 570.

In some implementations of the invention, a cell location indication 530 may be displayed that shows a location of a cell for which hotspots 570 are associated. In this manner, the location of a cell with which hotspots 570 are associated may be ascertained. In some implementations, cell location indication 530 may be shaped, sized, colored, etc., differently based on the overall quality of the mobile network based on hotspots 570. For example, when a majority of hotspots 570 are green or “good,” cell location indication 530 may be colored or highlighted green to indicate that the corresponding cell is providing good overall coverage.

In some implementations of the invention, hotspots 570 may be associated with a single cell. In other words, hotspots 570 may represent measurements of a single cell at various locations of the mobile network. In these implementations, a heat map display may be generated for each measured cell.

In some implementations of the invention, hotspots 570 may be associated with more than one cell. In other words, hotspots 570 may represent measurements of two or more cells at various locations of the mobile network. In these implementations, each cell may have its own shape, size, color, etc., coding scheme. In locations having measurements from two cells, a common scheme may be used.

FIG. 6 is a screen shot illustrating an example of a user interface 600 in bar chart mode, according to various implementations of the invention. According to various implementations of the invention, user interface 600 may include, among other things, an information panel 640, a navigation panel 650, a bar chart 680, a data indicator 682, and a data indicator 684. In some implementations, the menu mode is presented based on a selection of the menu mode within a navigation panel 650.

As illustrated, bar chart 680 represents measurements for a first measured cell and a second measured cell. Each bar may be colored, sized, shaped, etc., different based on the measurements. In some implementations of the invention, selection of a bar causes information for the cell corresponding to the selected bar to be displayed by information panel 640. In some implementations of the invention, data indicators 682 and 684 may each include text describing various measurements or data such as scrambling codes.

FIGS. 7A and 7B are diagrams illustrating components of a user interface, according to various implementations of the invention. FIG. 7A illustrates component 701, which examples of which are illustrated in various preceding figures. In some implementations of the invention, component 701 represents one or more measurements of a cell and a location where the measurements took place.

In some implementations of the invention, component 701 may include, among other things, a measurement location indication 710, and graphical representations 712, 714. Graphical representations 712, 714 each represent measurements of different cells taken at a location indicated by measurement location indication 710. Although illustrated as a cross-hair shape, measurement location indication 710 may be represented as any other visual or graphical cue. Similarly, although illustrated as generally conically shaped, graphical representations 712, 714 may be represented as any other visual or graphical cue.

As illustrated in FIG. 7A, each graphical representation 712, 714 is depicted as a cone having a vertex from which two arms 705 extend at an angle α and enclosed by an arc 703. The size/width of arc 703 is based on the length of the two arms 705 and a. In some implementations of the invention, a is based on a first measurement such as Ec/No while the length of each arm 705 is based on a second measurement such as RSCP. For example, a and/or the length of an arm 705 may be larger for better quality measurements. Thus, the size and/or shape of graphical representation 712, 714 may depend on measurements of a cell at a particular location. In some implementations, the color of graphical representation 712, 714 may be changed based on a quality of the measurements.

In some implementations of the invention, each graphical representation 712, 714 may be pointed toward a location of the cell that corresponds to the measurements represented by graphical representation 712, 714. As illustrated, for example, arms 705 may be equally spaced about an imaginary line from the vertex to the cell location. Thus, graphical representation 712, 714 will point toward the cell location (as indicated by cell location indication 730A, 730B) in FIG. 7B. In this manner, the quality of measurements at a particular measurement location and relative location of a responsible cell may be displayed. Although illustrated as conical, other shapes, such as arrows and rectangles may be used to point toward a cell location. Likewise, the size, shape, color, etc. of these other shapes may differ based on the measurements.

FIG. 7B illustrates component 701 with respect to a user interface 700. User interface 700 is a diagrammatic view of screenshots illustrated in various preceding figures. In some implementations of the invention, user interface 700 may include a background image 720, which may be a map, a floor plan, other image or no image, an overlay 722, an information panel 740 and a navigation panel 750.

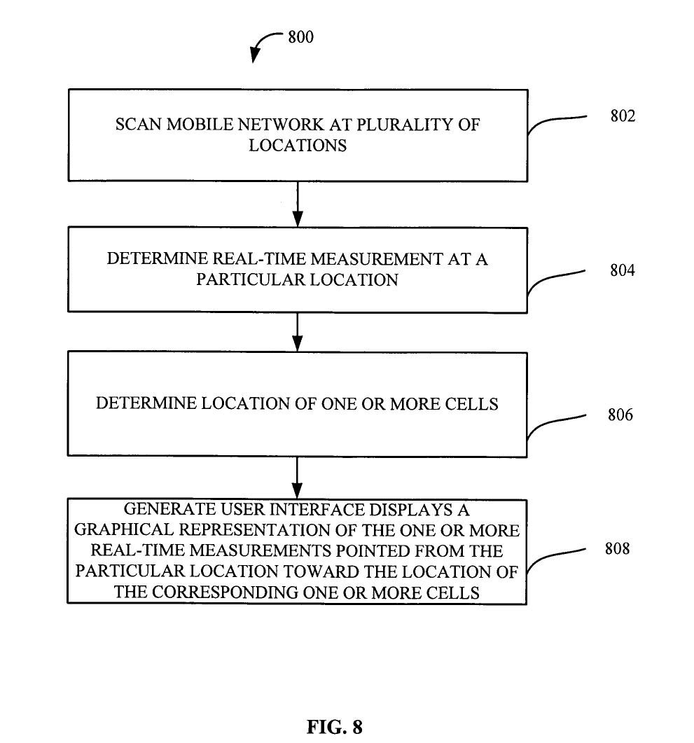

FIG. 8 is a flow diagram illustrating an example of a process 800 of scanning a mobile network, according to various implementations of the invention. The various processing operations and/or data flows depicted in FIG. 8 (and in the other drawing figures) are described in greater detail herein. The described operations for a flow diagram may be accomplished using some or all of the system components described in detail above and, in some implementations of the invention, various operations may be performed in different sequences. According to various implementations of the invention, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

In some implementations of the invention, in an operation 802 process 800 may scan a mobile network at a plurality of locations of mobile network 130. Mobile network 130 may be indoors and/or outdoors. As such, process 800 may scan indoors and/or outdoors.

In some implementations of the invention, in an operation 804 process 800 may determine one or more real-time measurements at a particular location among the plurality of location of the mobile network based on the scan. The real-time measurements may correspond to one or more corresponding cells of mobile network 130. Thus, scanning at a particular location may include scans of more than one cell.

In some implementations of the invention, in an operation 806 process 800 may determine a location of one or more cells corresponding to the one or more real-time measurements.

In some implementations of the invention, in an operation 808 process 800 may generate a user interface that displays a graphical representation of the one or more real-time measurements pointed from the particular location toward the location of the corresponding one or more cells. The user interface may include various graphical objects and displays discussed with respect to FIGS. 1-7. Process 800 may be used to scan indoor and/or outdoor locations and generate efficient displays to troubleshoot or otherwise view a mobile network while addressing the averaging problem and providing clear visualization of the measurements.

Implementations of the invention may be made in hardware, firmware, software, or any suitable combination thereof. Implementations of the invention may also be implemented as instructions stored on a machine readable medium, which may be read and executed by one or more processors. A tangible machine-readable medium may include any tangible, non-transitory, mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A computer implemented method of monitoring a mobile network via a mobile network scanner device, the method comprising:
scanning, by the mobile network scanner device, the mobile network at a plurality of locations of the mobile network, wherein scanning at each location occurs at different times;
determining, by the mobile network scanner device, one or more real-time measurements at a particular location among the plurality of locations of the mobile network based on the scan;
determining, by the mobile network scanner device, a location of one or more cells corresponding to the one or more real-time measurements; and
displaying, by the mobile network scanner device, a user interface that displays a graphical representation of the one or more real-time measurements pointed from the particular location toward the location of the corresponding one or more cells.

2. The computer implemented method of claim 1, wherein at least a portion of the mobile network is inside a building, the method further comprising:
receiving, by the mobile network scanner device, a floor plan of the building, wherein generating a user interface further comprises displaying the floor plan, and wherein receiving the location indication is based on the displayed floor plan.

3. The computer implemented method of claim 2, wherein displaying the floor plan comprises displaying the floor plan as a background and wherein generating a user interface further comprises overlaying at least a portion of the user interface onto the floor plan.

4. The computer implemented method of claim 1, wherein the location of one or more cell is unknown, the method further comprising: displaying, via the user interface, at least one cell location indication for the unknown location.

5. The computer implemented method of claim 1, further comprising:
receiving, by the mobile network scanner device, at least one cell location that indicates the location of one or more cells,
wherein generating a user interface further comprises: displaying at least one cell location indication that indicates the location of the one or more cells.

6. The computer implemented method of claim 5, wherein generating a user interface further comprises:
displaying a mobile network scanner device location indication based on a location of the mobile network scanner device during the scan; and
displaying the one or more measurements as a graphical object pointed substantially from the mobile network scanner device location indication toward the at least one cell location indication.

7. The computer implemented method of claim 6, wherein the graphical object is substantially conically shaped.

8. The computer implemented method of claim 2, wherein generating a user interface further comprises:
storing a plurality of the one or more real-time measurements;
generating a heat map display based on the stored plurality of one or more real-time measurements, wherein the heat map display is configured to display a first measurement of a corresponding first location differently than a second measurement of a corresponding second location based on their respective measurements and their respective locations.

9. The computer implemented method of claim 1, wherein the scanner device comprises a tablet device configured to scan the mobile network and display the user interface.

10. A computer readable medium having instructions stored thereon, the instructions when executed by one or more processors of a scanning device configure the scanning device to:
scan a mobile network at a plurality of locations of the mobile network;
determine one or more real-time measurements at a particular location among the plurality of locations of the mobile network based on the scan;
determine a location of one or more cells corresponding to the one or more real-time measurements; and
generate a user interface that displays a graphical representation of the one or more real-time measurements pointed from the particular location toward the location of the corresponding one or more cells.

11. The computer readable medium of claim 10, wherein at least a portion of the mobile network is inside a building, the instructions when executed further configured the scanning device to:
receive a floor plan of the building, wherein generate a user interface further comprises display the floor plan, and wherein receive the location indication is based on the displayed floor plan.

12. The computer readable medium of claim 11, wherein display the floor plan comprises display the floor plan as a background and wherein generate a user interface further comprises overlay at least a portion of the user interface onto the floor plan.

13. The computer readable medium of claim 10, the instructions when executed further configured the scanning device to:
receive at least one cell location that indicates the location of one or more cells,
wherein generate a user interface further comprises: display at least one cell location indication that indicates the location of the one or more cells.

14. The computer readable medium of claim 13, wherein generate a user interface further comprises:
display a mobile network scanner device location indication based on a location of the mobile network scanner device during the scan; and
display the one or more measurements as a graphical object pointed substantially from the mobile network scanner device location indication toward the at least one cell location indication.

15. The computer readable medium of claim 14, wherein the graphical object is substantially conically shaped.

16. The computer readable medium of claim 10, wherein generate a user interface further comprises:
store a plurality of the one or more real-time measurements;
generate a heat map display based on the stored plurality of one or more real-time measurements, wherein the heat map display is configured to display a first measurement of a corresponding first location differently than a second measurement of a corresponding second location based on their respective measurements and their respective locations.

17. A scanning device, comprising:
one or more processors configured to:
scan a mobile network at a plurality of locations of the mobile network;
determine one or more real-time measurements at a particular location among the plurality of locations of the mobile network based on the scan;
determine a location of one or more cells corresponding to the one or more real-time measurements; and
generate a user interface that displays a graphical representation of the one or more real-time measurements pointed from the particular location toward the location of the corresponding one or more cells.

18. The scanning device of claim 17, wherein at least a portion of the mobile network is inside a building, the one or more processors further configured to:
receive a floor plan of the building, wherein generate a user interface further comprises display the floor plan, and wherein receive the location indication is based on the displayed floor plan.

19. The scanning device of claim 18, wherein display the floor plan comprises display the floor plan as a background and wherein generate a user interface further comprises overlay at least a portion of the user interface onto the floor plan.

20. The scanning device of claim 17, wherein the mobile network comprises at least one cell, the one or more processors further configured to:
receive at least one cell location that indicates the location of one or more cells,
wherein generate a user interface further comprises: display at least one cell location indication that indicates the location of the one or more cells.

21. The scanning device of claim 20, wherein generate a user interface further comprises:
display a mobile network scanner device location indication based on a location of the scanning device during the scan; and
display the one or more measurements as a graphical object pointed substantially from the mobile network scanner device location indication toward the at least one cell location indication.

22. The scanning device of claim 21, wherein the graphical object is substantially conically shaped.

23. The scanning device of claim 17, wherein generate a user interface further comprises:
store a plurality of the one or more real-time measurements;
generate a heat map display based on the stored plurality of one or more real-time measurements, wherein the heat map display is configured to display a first measurement of a corresponding first location differently than a second measurement of a corresponding second location based on their respective measurements and their respective locations.

24. A computer implemented method of monitoring a network via a mobile network scanner device, the method comprising:
scanning, by the mobile network scanner device, a mobile network at a plurality of locations of the mobile network, wherein scanning at each location occurs at different times;
determining, by the mobile network scanner device, one or more measurements at each of a corresponding one of the plurality of locations of the mobile network based on the scan;
for each of the plurality of locations: receiving, by the mobile network scanner device, a location indication, wherein the location indication indicates a location of the mobile network at which a corresponding one of the one or more measurements are determined;
generating, by the mobile network scanner device, a user interface that displays a heat map based on the one or more measurements and corresponding location indications, wherein the heat map differentiates a first measurement at a first location from a second measurement at a second location.

25. The computer implemented method of claim 24, wherein the one or more measurements measure a first cell, the method further comprising: displaying a first location indication for a cell for which the one or more measurements pertain, wherein the first location indication indicates a location of the first cell with respect to the location indications corresponding to the one or more measurements.
